(19) United States
(12) Patent Application Publication
(10) Pub. No.: US 2005/0276474 A1
(43) Pub. Date: Dec. 15, 2005

(54) Gamut mapping apparatus using vector stretching and method thereof

(76) Inventors: Jin-sub Um, Suwon-si (KR); Moon-cheol Kim, Suwon-si (KR); Yoon-cheol Shin, Seongnam-si (KR)

Correspondence Address: STANZIONE & KIM, LLP, 919 18TH STREET, N.W., SUITE 440, WASHINGTON, DC, 20006, US

(21) Appl. No.: 11/142,326

(22) Filed: Jun. 2, 2005

(30) Foreign Application Priority Data
Jun. 11, 2004 (KR) 2004-43088

(51) Int. Cl. G06K 1/00; H04N 1/60

(52) U.S. Cl. 382/167

(57) ABSTRACT

A gamut mapping apparatus and method using a vector stretching that increases lightness and chroma depending on the shape of a gamut under a consistent chromaticity of a color signal of a source device. The gamut mapping apparatus may include a first color space conversion block to convert an input color signal into a first color signal of a LCH color space; a vector stretching block to perform the gamut mapping and to output a second color signal; and a second color space conversion block to convert the second color signal into a color space of the input color signal. The gamut mapping may be carried out under the consistent chromaticity such that a frequency of discoloration decreases. Also, gamut mapping can be performed after the source and the target gamuts are calibrated such that adverse effects caused by geometrical characteristics of the gamut and a decrease in chroma are reduced.

### CROSS-REFERENCE TO RELATED APPLICATIONS

This application claims the benefit of Korean Patent Application No. 2004-43088 filed on Jun. 11, 2004, in the Korean Intellectual Property Office, the disclosure of which is incorporated herein by reference in its entirety.

### BACKGROUND OF THE INVENTION

1. Field of the Invention

The present general inventive concept relates to a gamut mapping apparatus using a vector stretching, and a method thereof; and more particularly, to a gamut mapping apparatus using a vector stretching that increases brightness based on the shape of a gamut while maintaining chromaticity of a signal from a source device consistently, and a method thereof.

2. Description of the Related Art

Generally, image reproducing apparatuses such as monitors, scanners, printers and so on adopt different color spaces or color models depending on fields of the application. For instance, color printing apparatuses use a color space of CMY, which stands for cyan, magenta and yellow, and color cathode ray tube (CRT) monitors or computer graphic devices use a color space of RGB, which stands for red, green and blue. Those devices that must manipulate hue, saturation and intensity use a color space of HSI, which stands for hue, saturation and intensity. Also, the CIE color space based on human perception developed by the Commission Internationale de I'Eclairage (CIE) committee is used to reproduce images accurately in any device. That is, the CIE color space is employed when it is necessary to define device independent color systems. Also, the CIE color space is representatively classified into the CIE-XYZ color space, the CIE L*a*b color and CIE L*u*v color space.

Besides the color space, the color reproducing apparatuses may have different color gamuts. While the color space refers to a way of representing colors, that is, a relationship of the colors with respect to one another, the gamut is a range of colors that can be reproduced. Therefore, when an input color signal has a different gamut from that of a color reproducing apparatus, a gamut mapping that converts the input color signal into an adequate form that can be matched with the gamut of the color reproducing apparatus is required to improve color reproducibility.

Although the color reproducing apparatuses typically use three primary colors, currently there is an attempt to extend the color gamut using more than four defining colors. For instance, a multi-primary display (MPD) is a display system with extended color reproducibility by using more than four defining colors to expand a color gamut to a greater extend as compared with that of a three channel display system that uses three primary defining colors.

FIG. 1 is a diagram showing a conventional gamut mapping method using a chroma stretching.

The conventional gamut mapping method using the chroma stretching increases and decreases chroma by maintaining the same lightness (brightness). This gamut mapping method provides images with high definition when the chroma is improved.

Referring to FIG. 1, S and T are a source gamut and a target gamut, respectively. A region X is a region where the gamut extends towards chroma during the gamut mapping since here the target gamut is wider than the source gamut. Also, a region Y is a region where the gamut retracts towards the chroma during the gamut mapping since here the target gamut is narrower than the source gamut. A line K represents a line where chroma increases in proportion to an increase in lightness (brightness) from the source gamut to a portion corresponding to primary colors or highly chromatic colors.

However, as indicated in the line K in FIG. 1, the conventional gamut mapping method using the chroma stretching has a problem in that chroma decreases in a region where the chroma increases as lightness increases, i.e., in the region Y, during the gamut mapping.

### SUMMARY OF THE INVENTION

The present general inventive concept provides a gamut mapping apparatus using a vector stretching to increase and decrease lightness (brightness) calibrated into characteristics of a target device by maintaining colors of color signals of a source device consistent during a gamut mapping between color systems with different color gamuts, and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an apparatus to provide a gamut mapping using a vector stretching, including: a first color space conversion block to convert an input color signal into a first color signal of an LCH (light, chroma and hue) color space; a vector stretching block to output a second color signal obtained as a source point of a source gamut of the first color signal mapped to a transferred target point of a target gamut of a target device to reproduce the input color signal as much as a vector difference between a point at which an extended line of a vector of the source point meets with a boundary line of the source gamut and a point at which the extended line of the vector meets with a boundary line of the target gamut; and a second color space conversion block to convert the second color signal into a color space of the input color signal.

The gamut mapping carried out by the vector stretching block is defined as:

$${l}_{t} = {l}_{s} \cdot \frac{{l}_{tg}}{{l}_{sg}} , {c}_{t} = {c}_{s} \cdot \frac{{c}_{tg}}{{c}_{sg}} ,$$

where (cₛ,lₛ), (cₜ,lₜ), (c_{sg},l_{sg}) and (c_{tg},l_{t g}) are a source point of the source gamut, a mapped target point, a point at which an extended line of a vector of the source point meets with a boundary line of the source gamut, and a point at which the extended line of the vector meets with a boundary line of the target gamut, respectively.

Also, the gamut mapping apparatus may further include a source gamut calibration unit to calibrate a cusp of a predetermined boundary line of the source gamut to have the same slope of a boundary line of the target gamut adjacent to the source gamut before the vector stretching block performs a gamut mapping.

The source gamut calibration unit calibrates the source gamut on the basis of an equation defined as:

$$if o \leq l \leq {l}_{o} , {l}^{′} = l + ( {l}_{n} - {l}_{o} ) \cdot \frac{l}{{l}_{o}} , \\ if , {l}_{o} \leq l \leq 1 , {l}^{′} = l + ( {l}_{n} - {l}_{o} ) \cdot \frac{l - {l}_{o}}{1 - {l}_{o}} , \\ {c}^{′} = c \cdot \frac{{c}_{n}}{{c}_{o}}$$

where (c,l), (c′,l′), (cₒ,lₒ) and (cₙ,lₙ) represent a first source point of the source gamut, a second source point of the source gamut after the calibration, a first cusp of the source gamut prior to the calibration executed by the source gamut calibration unit and a second cusp of the source gamut after the calibration, respectively.

Moreover, the gamut mapping apparatus may further include a target gamut calibration unit to calibrate the boundary line of the target gamut before the source gamut calibration unit calibrates the source gamut. Herein, the target gamut calibration unit calibrates the target gamut when a cusp exists at the boundary line of the target gamut adjacent to the predetermined boundary line of the source gamut calibrated by the source gamut calibration unit.

The gamut mapping apparatus may further include a hue shift unit to perform a shift to reduce the target gamut prior to the gamut mapping executed by the vector stretching block when the source gamut is wider than the target gamut.

Also, the gamut mapping apparatus may further include a chroma stretching unit to perform a chroma stretching to a region that is not mapped after the vector stretching block performs the gamut mapping.

The foregoing and/or other aspects of the present general inventive concept are also achieved by providing a method of performing a gamut mapping using a vector stretching, the method including: converting an input color signal into a first color signal of an LCH color space and outputting the converted signal; outputting a second color signal obtained as a source point of a source gamut of the first color signal mapped to a transferred target point of a target gamut of a target device to reproduce the input color signal as much as a vector difference between a point at which an extended line of a vector of the source point meets with a boundary line of the source gamut and a point at which the extended line of the vector meets with a boundary line of the target gamut; and converting the second color signal into a color space of the input color signal and outputting the converted color signal.

The gamut mapping carried out by using the vector stretching is defined as:

$${l}_{t} = {l}_{s} \cdot \frac{{l}_{tg}}{{l}_{sg}} , {c}_{t} = {c}_{s} \cdot \frac{{c}_{tg}}{{c}_{sg}}$$

where (cₛ,lₛ), (cₜ,lₜ), (c_{sg},l_{sg}) and (c_{tg},l_{t g}) are a source point of the source gamut, a mapped target point, a point at which an extended line of a vector of the source point meets with a boundary line of the source gamut, and a point at which the extended line of the vector meets with a boundary line of the target gamut, respectively.

Also, the method may further include calibrating a cusp of a predetermined boundary line of the source gamut to have the same slope of a boundary line of the target gamut adjacent to the source gamut prior to the gamut mapping.

Particularly, the source gamut calibration is carried out on the basis of an equation defined as:

$$if o \leq l \leq {l}_{o} , {l}^{′} = l + ( {l}_{n} - {l}_{o} ) \cdot \frac{l}{{l}_{o}} , \\ if {l}_{o} \leq l \leq 1 , {l}^{′} = l + ( {l}_{n} - {l}_{o} ) \cdot \frac{l - {l}_{o}}{1 - {l}_{o}} , \\ {c}^{′} = c \cdot \frac{{c}_{n}}{{c}_{o}}$$

where (c,l), (c′,l′), (cₒ,lₒ) and (cₙ,lₙ) represent a first source point of the source gamut, a second source point of the source gamut after the calibration, a first cusp of the source gamut prior to the calibration of the source gamut and a second cusp of the source gamut after the calibration, respectively.

At this time, the predetermined boundary line of the source gamut to which the cusp calibration is applied is a region corresponding to primary colors of the source gamut and has chroma increasing as lightness increases.

The method may further include calibrating the boundary line of the target gamut before the source gamut is calibrated. At this time, this operation of calibrating the boundary line of the target gamut proceeds with the target gamut calibration when a cusp exists at the boundary line of the target gamut adjacent to the predetermined boundary line of the calibrated source gamut.

The method may further include performing a hue shift to reduce the target gamut prior to the gamut mapping when the source gamut is wider than the target gamut.

Additionally, the method may further include performing a chroma stretching to a region that is not mapped after the gamut mapping is carried out by using the vector stretching.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram showing a conventional gamut mapping method using a chroma stretching;

FIG. 2 is a block diagram showing a gamut mapping apparatus using a vector stretching in accordance with an embodiment of the present invention;

FIG. 3 is a flowchart describing a gamut mapping method using a vector stretching in accordance with the embodiment of the present invention;

FIG. 4 is a detailed diagram describing operation of a hue shift unit shown in FIG. 2;

FIG. 5 is a detailed diagram describing operation of a vector stretching unit shown in FIG. 2;

FIGS. 6A and 6B are detailed diagrams describing operation of a source gamut calibration unit shown in FIG. 2; and

FIG. 7 is a detailed diagram describing operation of a target gamut calibration unit shown in FIG. 2.

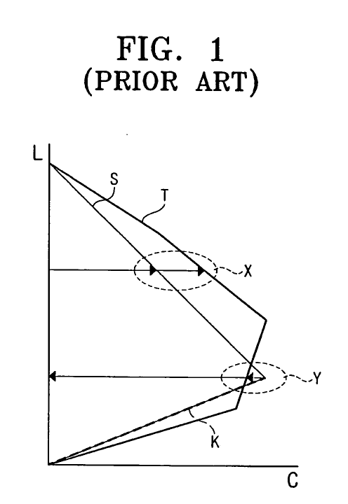

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

In the following description, same drawing reference numerals are used for the same elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

Disclosed is a gamut mapping apparatus and method using a vector stretching in a source device and a target device with different color gamuts. Hereinafter, a three-channel color device and a five-channel color device are exemplified as the source device and the target device, respectively. The disclosed gamut mapping method can be applied to a mapping from a source gamut to a target gamut in color reproducing apparatuses with different color gamuts.

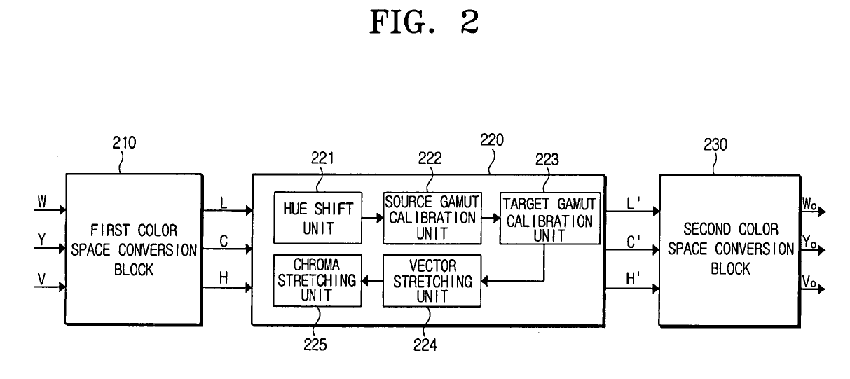

FIG. 2 is a block diagram illustrating a gamut mapping apparatus using a vector stretching method in accordance with an embodiment of the present general inventive concept.

As illustrated in FIG. 2, the gamut mapping apparatus using a vector stretching method may include a first color space conversion block 210, a gamut mapping block 220, and a second color space conversion block 230. The gamut mapping block 220 may include a hue shift unit 221, a source gamut calibration unit 222, a target gamut calibration unit 223, a vector stretching unit 224, and a chroma stretching unit 225.

The first color space conversion block 210 coverts an input color signal into coordinates of LCH, which stands for lightness, chroma and hue since the gamut mapping takes place at a constant hue plane to maintain colors consistently.

Also, the gamut mapping block 220 to which the input color signal converted by the first color space conversion block 210 is input maps a source color gamut of the source apparatus to a target color gamut of the target apparatus at the LCH coordinates.

The hue shift unit 221 shifts the target gamut when the source gamut and the target gamut are highly different from each other. For example, in a case in which the source gamut is wider than the target gamut, a hue shift is performed under the target by decreasing the target gamut to prevent discoloration and desaturation caused by a decrease in chroma and lightness during the gamut mapping.

Prior to the gamut mapping, the source gamut calibration unit 222 calibrates a cusp of the source gamut to be disposed at an extended line having the same slope as a cusp of the target gamut adjacent to the cusp of the source gamut. That is, a region of the source gamut disposed outside the target gamut is downsized prior to the gamut mapping, or a region of the source gamut disposed inside the target gamut is enlarged prior to the gamut mapping.

The target gamut calibration unit 223 calibrates the target gamut when the source gamut calibrated by the source gamut calibration unit 222 is highly different from the target gamut in comparison with the original source gamut that is not calibrated. In other words, the target gamut calibration unit 223 calibrates the target gamut when there is a high discrepancy in chroma and lightness between a cusp of a predetermined boundary line of the source gamut calibrated by the source gamut calibration unit 222 and a cusp of a predetermined boundary line of the target gamut, which is a reference for the source gamut calibration.

The vector stretching unit 224 carries out a gamut mapping by employing a vector stretching method when a predetermined source point of the source gamut is mapped to a target point of the target gamut. That is, a source point at the source gamut is mapped to the target point by being stretched as much as a vector difference between a point at which the extended line of the vector meets with the boundary line of the source gamut and a point at which the extended line of the vector meets with the boundary line of the target gamut.

After the mapping of the source gamut by the vector stretching unit 224, the chroma stretching unit 225 carries out the gamut mapping by employing a chroma stretching for those regions of the target gamut that are not subjected to the vector stretching.

The second color space conversion block 230 converts the input color signal at the LCH color space mapped by the gamut mapping block 220 into a color space of WYV and outputs the converted color signal.

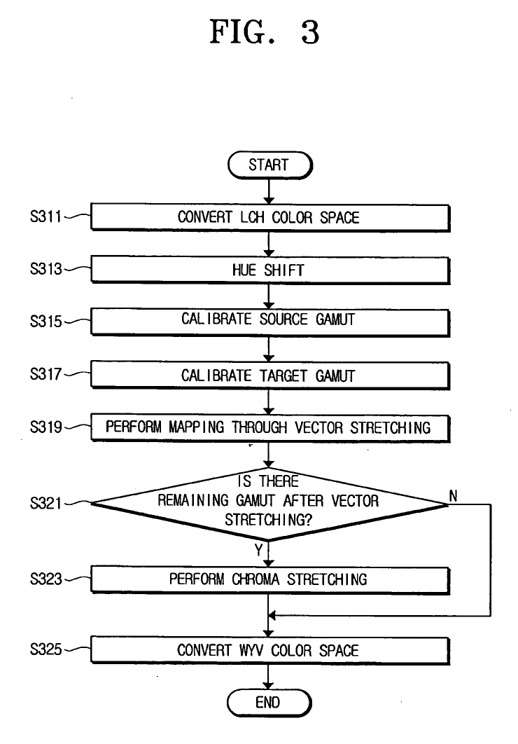

FIG. 3 is a flowchart illustrating a gamut mapping method using the above-described vector stretching in accordance with an embodiment of the present general inventive concept.

As illustrated in FIG. 3, at operation S311, the first color space conversion unit 210 first converts an input color signal into a color signal of the LCH color space. This conversion of the input color signal is necessary since the gamut mapping takes place at a constant hue plane to maintain colors consistently.

Coordinates of the LCH color space are converted from a color coordinate system representing brightness and chromaticity. Examples of the color coordinate system are CIE L*a*b, CIE L*u*v, YCbCr and so forth, and these color coordinate systems generally take red-green and yellow-blue as an axis of chromaticity. In this embodiment, WYV coordinates that are linearly converted from XYZ coordinates are described as an example. That is, the color space conversion from the WYV coordinates to the LCH coordinates are defined by the following mathematical equation.

$$L = Y \\ C = \sqrt{{W}^{2} + {V}^{2}} \\ H = {tan}^{- 1} ( \frac{V}{W} ) \qquad EQUATION 1$$

Next, at operation S313, the input color signal converted into the LCH color space is subjected to a hue shift operation by the hue shift unit 221. The hue shift is carried out to prevent discoloration and desaturation caused by a decrease in lightness and chroma which may occur during the gamut mapping when a source gamut is highly different from a target gamut. The discoloration is generally observed when the source gamut is wider than the target gamut. Thus, in a case in which the source gamut is wider than the target gamut, the target gamut is shifted under the target by enlarging the target gamut. However, when the source gamut and the target gamut exhibit a slight difference that does not induce the discoloration, the hue shift of the source gamut or the target gamut is not required. A degree of the hue shift depends on a shifted hue distance, and an amount of the hue shift is also adjusted in order to prevent an incidence of color contour phenomenon caused by the hue shift.

Prior to the gamut mapping, at operation S315, the source gamut calibration unit 222 calibrates the source gamut. The source gamut calibration is carried out such that a cusp of the source gamut is calibrated to be disposed at an extended line having the same slope to a cusp of the target gamut adjacent to the cusp of the source gamut. Depending on a degree of calibrating the cusp of the source gamut, those points in the source gamut are also calibrated. When the source gamut is narrower than the target gamut, the source gamut is calibrated to be enlarged according to the degree of the above cusp calibration. Conversely, when the source gamut is wider than the target gamut, the source gamut is calibrated to be downsized according to the degree of the above cusp calibration.

At operation S317, the target gamut calibration unit 223 calibrates the target gamut to prevent colors from being clustered at a boundary line of the source gamut. The color cluster phenomenon may occur because of the source gamut calibration. More specifically, the color cluster phenomenon arises when the target gamut includes a cusp of another target gamut at a region where the source gamut calibration unit 222 calibrates the cusp of the source gamut to be disposed at the extended line of the cusp of the target gamut. Hence, in a case in which the target gamut does not have another cusp at the region where the aforementioned calibration by the source gamut calibration unit 222 takes place, the target gamut calibration unit 223 does not calibrate the target gamut. That is, when the color cluster of the source gamut does not occur during the gamut mapping by the source gamut calibration, the target gamut calibration is unnecessary.

The target gamut calibration takes place by removing the cusp of the target gamut at the region where the cusp of the source gamut is calibrated to be placed at the extended line of the cusp of the target gamut adjacent to the cusp of the source gamut.

At operation S319, the gamut mapping takes place by performing the vector stretching executed by the vector stretching unit 224. That is, a source point at the source gamut is mapped to a target point at the target gamut as much as a vector difference between a point at which an extended line of a vector of a certain source point at the source gamut meets with a boundary line of the source gamut and a point at which the extended line of the vector meets with a boundary line of the target gamut. At this time, the gamut mapping can be carried out without calibrating the source gamut and the target gamut through employing the vector stretching.

After the gamut mapping by the vector stretching, at operation S321, it is determined whether or not there is a region to which the vector stretching cannot be applied. This region is commonly discovered when the source gamut calibration unit 222 does not calibrate the source gamut, or after the source gamut calibration unit 222 and the target gamut calibration unit 223 make the calibration.

At operation S323, in a case where there is such a region to which the vector stretching cannot be applied, a chroma stretching is applied thereto. Even though the chroma stretching is applied, an incidence of desaturation typically arising after the chroma stretching is not observed during the gamut mapping. The reason for this effect is because the chroma stretching is applied to the region where the vector stretching is not carried out after the source gamut calibration unit 222 and the target gamut calibration unit 223 calibrate the source gamut and the target gamut, respectively, prior to the gamut mapping by the vector stretching.

However, if there is not such a region to which the vector stretching is not applied, the gamut mapping is carried out by the vector stretching without applying the chroma stretching. In addition, the gamut mapping involves only the vector stretching when the source gamut calibration takes place while the target gamut calibration does not take place.

Next, in a case in which the gamut mapping takes place by the gamut mapping block 220 which includes the hue shift unit 221, the source gamut calibration unit 222, the target gamut calibration unit 223, the vector stretching unit 224 and the chroma stretching unit 225, at operation S325, the second color space conversion block 230 converts the LCH coordinates outputted from the gamut mapping block 220 into the WYV coordinates.

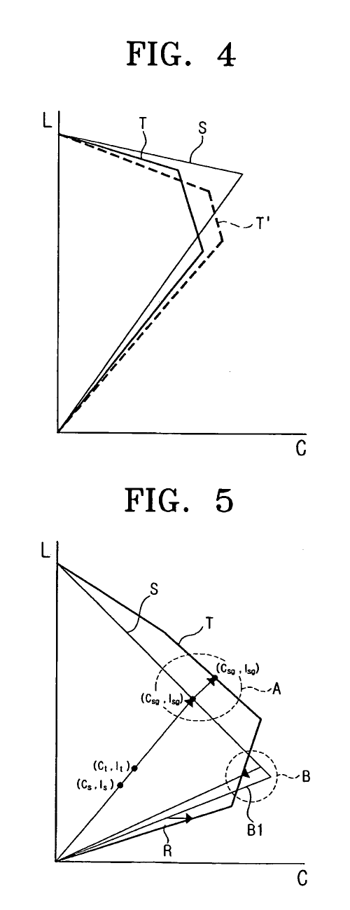

FIG. 4 is a detailed diagram illustrating operations of the hue shift unit 221 illustrated in FIG. 2.

Reference denotations S and T in FIG. 4 refer to a source gamut and a target gamut, respectively. A reference denotation T′ represents a shifted target gamut adjacent to the target gamut not being calibrated. FIG. 4 depicts the case in which the source gamut S is wider than the target gamut T. In this case, if a hue shift is not applied, an incidence of discoloration caused by a decrease in chroma and lightness occurs. Thus, among gamut regions corresponding to other colors around the target gamut T, the hue shift is applied to a region where the discoloration can be minimized. Since a gamut mapping takes place by employing the target gamut with the hue shifted, it is possible to prevent the discoloration problem. A degree of the hue shift is adjusted according to a shifted hue distance shifted, and an amount of the hue shift is also adjusted in order to prevent an incidence of color contour phenomenon caused by the hue shift. However, in a case in which a discrepancy between the source gamut and the target gamut is too minor to generate a color contour phenomenon, the gamut mapping can be performed by the vector stretching without the hue shift.

At this time, the discoloration caused by a discrepancy in the size between the source gamut and the target gamut occurs when the source gamut is wider than the target gamut. As a result, the hue shift takes place when the target gamut is shifted closely toward the source gamut.

FIG. 5 is a detailed diagram illustrating operations of the vector stretching unit 224 illustrated in FIG. 2.

Reference denotations S and T refer to a source gamut and a target gamut, respectively. Also, a region A represents a region where the source gamut extends during a vector stretching operation because the source gamut is narrower than the target gamut, and a region B represents a region where the source gamut is downsized during the vector stretching because the source gamut is wider than the target gamut. Further, a region R refers to a region where the vector stretching cannot be applied because the target gamut is wider than the source gamut to which the vector stretching is applied through employing the vector stretching unit 224.

The vector stretching unit 224 performs the vector stretching to each source point on the basis of the following mathematical equation defined as: lsg

$${l}_{t} = {l}_{s} \cdot \frac{{l}_{tg}}{{l}_{sg}} \\ {c}_{t} = {c}_{s} \cdot \frac{{c}_{tg}}{{c}_{sg}} \qquad EQUATION 2$$

Herein, (cₛ,lₛ) is a source point of the source gamut and (cₜ,lₜ) is a mapped target point. Also, (c_{sg},l_{sg}) is a point at which an extended line of a vector of the source point meets with a boundary line of the source gamut, and (c_{tg},l_{t g}) is a point at which the extended line of the vector meets with a boundary line of the target gamut.

That is, according to the above mathematical equation 2, the source point is mapped to the target point as much as a vector difference between the point at which the extended line of the vector meets with the boundary line of the source gamut and the point at which the extended line of the vector meets with the boundary line of the target gamut.

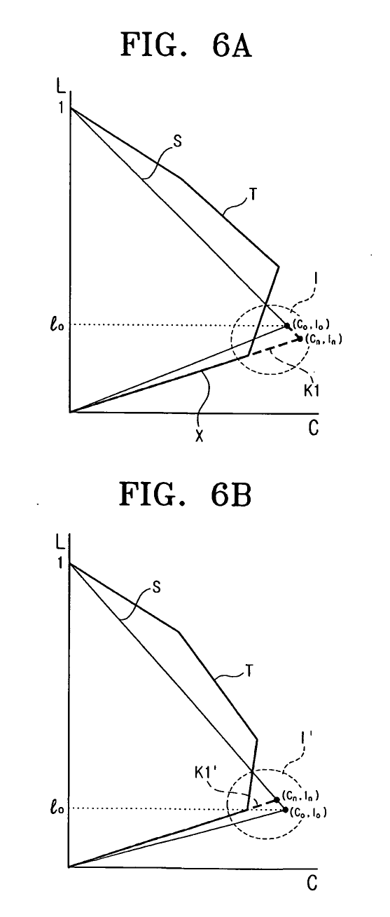

FIGS. 6A and 6B are detailed diagrams illustrating operations of the source gamut calibration unit 222 illustrated more specifically in FIG. 2. FIG. 6A depicts the case of extending a source gamut when the source gamut is narrower than a target gamut. FIG. 6B depicts the case of reducing the source gamut when the source gamut is wider than the target gamut.

With reference to FIGS. 6A and 6B, reference denotations S and T represent the source gamut and the target gamut, respectively. Also, a region I represents a region where a cusp of the source gamut is calibrated to extend, and a region I′ represents a region where a cusp of the source gamut is calibrated to decrease. In the regions I and I′, the cusps of the source gamut are calibrated to be placed at extended lines of cusps of the target gamut adjacent to the respective cusps of the source gamut. That is, the cusp of the source gamut in FIG. 6A is disposed at a line K1, while the cusp of the source gamut in FIG. 6B is disposed at a line K1′.

Referring to FIG. 6A, the case of extending the source gamut because the source gamut is narrower than the target gamut will be explained. A line X is a line where desaturation occurs during a gamut mapping. For the line X, in a case in which a chroma stretching is additionally applied to a remaining region of the target gamut after the application of the vector stretching without the source gamut calibration, saturation in the upper side of the cusp abruptly decreases while the saturation increases up to the cusp of the target gamut. Therefore, saturation of those colors mapped in the upper side of the cusp of the target gamut appears to be decreasing in the line X. The cusp of the source gamut is calibrated as shown in FIG. 6A to prevent such relative desaturation at the upper side of the cusp of the target gamut. Accordingly, the source gamut extends as much as the target gamut, thereby eliminating the desaturation phenomenon.

Referring to FIG. 6B, the case of reducing the source gamut because the source gamut is wider than the target gamut will be explained. The reason for calibrating the cusp of the source gamut as illustrated in FIG. 6B is to prevent an incidence of mis-mapping, in which the gamut mapping value becomes 0 since the source gamut is wider than the target gamut. Therefore, similar to the scheme described in FIG. 6A, as the cusp of the source gamut is calibrated to the extended line of the target gamut, the source gamut is reduced as much as the target gamut, thereby eliminating the mis-mapping phenomenon.

As described above with reference to FIGS. 6A and 6B, the calibration of the source gamut is undergone as the following mathematic equations defined as:

$$\begin{matrix}{l}^{′} = l + ( {l}_{n} - {l}_{o} ) \cdot \frac{l}{{l}_{o}} , if o \leq l \leq {l}_{o} & EQUATION 3 \\ {l}^{′} = l + ( {l}_{n} - {l}_{o} ) \cdot \frac{l - {l}_{o}}{1 - {l}_{o}} , if {l}_{o} \leq l \leq 1 & EQUATION 4 \\ {c}^{′} = c \cdot \frac{{c}_{n}}{{c}_{o}} & EQUATION 5\end{matrix}$$

In the above mathematical equations 3 to 5, (c,l) is a source point of the source gamut, and (c′,l′) is a calibrated source point of the source gamut. Also, (c₀,l₀) is a cusp of the source gamut prior to the calibration, and (cₙ,lₙ) is a cusp of the source gamut after the calibration.

In the case in which o≦l≦lₒ, that is, in case that the source point of the source gamut has a value less than a lightness (lₒ) of the cusp of the source gamut, the source point is calibrated in proportion to a calibrated amount of the cusp of the source gamut by the source gamut calibration unit 222. Thus, the lightness of the source point after the calibration is defined as the mathematical equation 3 above. Meanwhile, in the case in which lₒ≦l≦1, that is, in a case in which the source point of the source gamut has a value greater than the lightness (lₒ) of the cusp of the source gamut, the source point is calibrated in proportion to a calibrated amount of the cusp of the source gamut by the source gamut calibration unit 222. Thus, the lightness of the source point after the calibration is defined as the mathematical equation 4 above. Since FIG. 6A exemplifies the case in which the cusp of the source gamut is extended, the lightness of the source gamut decreases in proportion to a calibrated lightness amount of the cusp of the source gamut. In a case in which the cusp of the source gamut is reduced as shown in FIG. 6B, the lightness of the source gamut increases in proportion to a calibrated lightness amount of the cusp of the source gamut.

At this time, a boundary line of the source gamut of which the cusp is calibrated by the source gamut calibration unit 222 corresponds to a region for primary colors of the source gamut. Also, in this region, chroma increases as the lightness of the input color signal increases. In addition, chroma of the cusp of the source gamut is calibrated according to the mathematical equation 5 above.

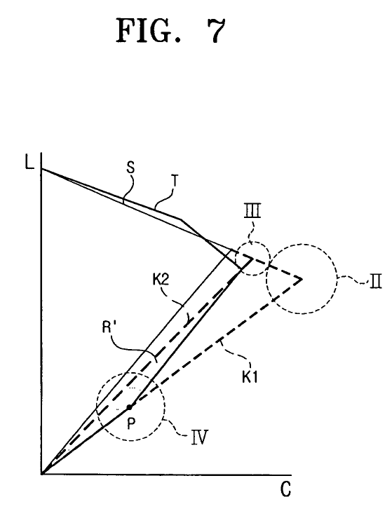

FIG. 7 is a detailed diagram illustrating operations of the target gamut calibration unit illustrated in FIG. 2.

Similar to FIG. 6A, FIG. 7 exemplifies a case in which a cusp of a source gamut is extended since the source gamut is narrower than a target gamut. Also, reference denotations S and T refer to the source gamut and the target gamut, respectively. A line K1 refers to an extended line of a cusp of the target gamut, while a line K2 refers to a line in which the target gamut is calibrated by the target gamut calibration unit 223. Also, a reference denotation ‘p’ is one of cusps of the target gamut. Further, a region II represents the cusp of the source gamut calibrated by the source gamut calibration unit 222. That is, as illustrated in FIG. 6A, the region II of FIG. 7 represents a region where the cusp of the source gamut is calibrated to be disposed at the line K1, which is the extended line of a boundary line of the target gamut. A region III of FIG. 7 represents a region where the source gamut is calibrated by the source gamut calibration unit 222 on the basis of the target gamut calibrated. That is, the cups of the source gamut is calibrated to be disposed at the line K2, which is an extended line of a boundary line of a calibrated target gamut. Further, a region IV of FIG. 7 represents a region where the cusp of the source gamut is calibrated to be disposed at the line K1, i.e., the region where colors of the source gamut become clustered when the source gamut is calibrated by the source gamut calibration unit 222 on the basis of the target gamut under the state in which the target gamut is not calibrated and then the gamut mapping is performed. A region R′ represents a region where the vector stretching does not occur as like the region R in FIG. 5. The region R′ in FIG. 7 is a difference between the target gamut before and after the calibration.

Meanwhile, as described with reference to FIGS. 6A and 6B, when the source gamut is calibrated while the target gamut is not calibrated by the target gamut calibration unit 223, i.e., when the source gamut is calibrated to the region II in FIG. 7, the cusp of the source gamut is calibrated to the extended line of the line K1 of the target gamut, thereby resulting in the color cluster at the region IV during the gamut mapping. The target gamut is calibrated when there is a high discrepancy in chroma and lightness between a cusp of a predetermined boundary line of the source gamut calibrated by the source gamut calibration unit 222 and a cusp of a predetermined boundary line of the target gamut, which is a reference for the source gamut calibration. Therefore, the color cluster can be impaired by calibrating the target gamut as like the line K2 and then the cusp of the source gamut along the calibrated line K2 as illustrated in FIG. 7. The line K2 is obtained by calibrating the cusp of the target gamut to the boundary line of the target gamut having one slope while ignoring the one cusp existing at the boundary line of the target gamut.

The source gamut calibration and the target gamut calibration described with reference to FIGS. 6A, 6B and FIG. 7 are carried out to prevent chroma from decreasing during the gamut mapping. Even without the source gamut calibration and the target gamut calibration, the gamut mapping can be carried out using the vector stretching by the vector stretching unit 224 as described with reference to FIG. 5. When the gamut mapping is carried out by the vector stretching only, the chroma stretching is additionally applied to the region where the vector stretching cannot be applied. In a case in which the color cluster does not occur at the source gamut during the gamut mapping, the target gamut is calibrated by the target gamut calibration unit 223.

In comparison with the conventional gamut mapping using the chroma stretching, the disclosed gamut mapping using the vector stretching provides an effect in that the gamut mapping can be carried out under consistently maintained chromaticity. As a result of this effect, it is further possible to reduce a frequency of the discoloration phenomenon. Also, after the source gamut calibration and the target gamut calibration, the gamut mapping using the vector stretching makes it possible to prevent chroma from decreasing.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to provide a gamut mapping using a vector stretching, comprising:
a first color space conversion block to convert an input color signal into a first color signal of an LCH color space;
a vector stretching block to output a second color signal obtained as a source point of a source gamut of the first color signal mapped to a transferred target point of a target gamut of a target device to reproduce the input color signal as much as a vector difference between a point at which an extended line of a vector of the source point meets with a boundary line of the source gamut and a point at which the extended line of the vector meets with a boundary line of the target gamut; and
a second color space conversion block to convert the second color signal into a color space of the input color signal.

2. The apparatus of claim 1, wherein the gamut mapping carried out by the vector stretching block is defined as:
$${l}_{t} = {l}_{s} \cdot \frac{{l}_{tg}}{{l}_{sg}} , {c}_{t} = {c}_{s} \cdot \frac{{c}_{tg}}{{c}_{sg}}$$
where (c_{s,l}ₛ), (cₜ,lₜ), (c_{sg},l_{sg}) and (c_{tg},l_{t g}) are a source point of the source gamut, a mapped target point, a point at which an extended line of a vector of the source point meets with a boundary line of the source gamut, and a point at which the extended line of the vector meets with a boundary line of the target gamut, respectively.

3. The apparatus of claim 1, further including a source gamut calibration unit to calibrate a cusp of a predetermined boundary line of the source gamut to have the same slope of a boundary line of the target gamut adjacent to the source gamut before the vector stretching block performs a gamut mapping.

4. The apparatus of claim 3, wherein the source gamut calibration unit calibrates the source gamut on the basis of an equation defined as:
$$if o \leq l \leq {l}_{o} , {l}^{′} = l + ( {l}_{n} - {l}_{o} ) \cdot \frac{l}{{l}_{o}} , \\ if , {l}_{o} \leq l \leq 1 , {l}^{′} = l + ( {l}_{n} - {l}_{o} ) \cdot \frac{l - {l}_{o}}{1 - {l}_{o}} , \\ {c}^{′} = c \cdot \frac{{c}_{n}}{{c}_{o}}$$
where (c,l), (c′,l′), (cₒ,nₒ) and (cₙ,lₙ) represent a first source point of the source gamut, a second source point of the source gamut after the calibration, a first cusp of the source gamut prior to the calibration executed by the source gamut calibration unit and a second cusp of the source gamut after the calibration, respectively.

5. The apparatus of claim 3, wherein the predetermined boundary line of the source gamut to which the cusp calibration is applied is a region corresponding to primary colors of the source gamut and has chroma increasing as lightness increases.

6. The apparatus of claim 3, further including a target gamut calibration unit to calibrate the boundary line of the target gamut before the source gamut calibration unit calibrates the source gamut.

7. The apparatus of claim 6, wherein the target gamut calibration unit calibrates the target gamut when the cusp of the predetermined boundary line of the source gamut calibrated by the source gamut calibration unit and a cusp of the boundary line of the target gamut which is a reference for the source gamut calibration exhibit a high discrepancy in chroma and lightness.

8. The apparatus of claim 1, further including a hue shift unit to perform a shift to reduce the target gamut prior to the gamut mapping executed by the vector stretching block when the source gamut is wider than the target gamut.

9. The apparatus of claim 1, further including a chroma stretching unit to perform a chroma stretching to a region that is not mapped after the vector stretching block performs the gamut mapping.

10. A method of performing a gamut mapping using a vector stretching, comprising:
converting an input color signal into a first color signal of an LCH color space and outputting the converted signal;
outputting a second color signal obtained as a source point of a source gamut of the first color signal mapped to a transferred target point of a target gamut of a target device to reproduce the input color signal as much as a vector difference between a point at which an extended line of a vector of the source point meets with a boundary line of the source gamut and a point at which the extended line of the vector meets with a boundary line of the target gamut; and
converting the second color signal into a color space of the input color signal and outputting the converted color signal.

11. The method of claim 10, wherein the gamut mapping carried out by using the vector stretching is defined as:
$${l}_{t} = {l}_{s} \cdot \frac{{l}_{tg}}{{l}_{sg}} , {c}_{t} = {c}_{s} \cdot \frac{{c}_{tg}}{{c}_{sg}}$$
where (cₛ,lₛ), (cₜ,lₜ), (c_{sg},l_{sg}) and (c_{tg},l_{t g}) are a source point of the source gamut, a mapped target point, a point at which an extended line of a vector of the source point meets with a boundary line of the source gamut, and a point at which the extended line of the vector meets with a boundary line of the target gamut, respectively.

12. The method of claim 10, further including calibrating a cusp of a predetermined boundary line of the source gamut to have the same slope of a boundary line of the target gamut adjacent to the source gamut prior to the gamut mapping.

13. The method of claim 12, wherein the source gamut calibration is carried out on the basis of an equation defined as:
$$if o \leq l \leq {l}_{o} , {l}^{′} = l + ( {l}_{n} - {l}_{o} ) \cdot \frac{l}{{l}_{o}} , \\ if {l}_{o} \leq l \leq 1 , {l}^{′} = l + ( {l}_{n} - {l}_{o} ) \cdot \frac{l - {l}_{o}}{1 - {l}_{o}} , \\ {c}^{′} = c \cdot \frac{{c}_{n}}{{c}_{o}}$$
where (c,l), (c′,l′), (cₒ,l′) and (cₙ,lₙ) represent a first source point of the source gamut, a second source point of the source gamut after the calibration, a first cusp of the source gamut prior to the calibration of the source gamut and a second cusp of the source gamut after the calibration, respectively.

14. The method of claim 12, wherein the predetermined boundary line of the source gamut to which the cusp calibration is applied is a region corresponding to primary colors of the source gamut and has chroma increasing as lightness increases.

15. The method of claim 12, further including calibrating the boundary line of the target gamut before the source gamut is calibrated.

16. The method of claim 15, wherein at the operation of calibrating the boundary line of the target gamut, the target gamut is calibrated when the cusp of the predetermined boundary line of the source gamut and a cusp of the boundary line of the target gamut which is a reference for the source gamut calibration exhibit a high discrepancy in chroma and lightness.

17. The method of claim 10, further including the operation of performing a hue shift to reduce the target gamut prior to the gamut mapping when the source gamut is wider than the target gamut.

18. The method of claim 10, further including the operation of performing a chroma stretching to a region that is not mapped after the gamut mapping is carried out by using the vector stretching.

19. An apparatus to provide a gamut mapping using a vector stretching, comprising:
a gamut mapping block to receive a first color signal of an LCH color space converted from an initial color signal and to output a second color signal obtained as a source point of a source gamut of the first color signal mapped to a transferred target point of a target gamut of a target device to reproduce the initial color signal as much as a vector difference between a point at which an extended line of a vector of the source point meets with a boundary line of the source gamut and a point at which the extended line of the vector meets with a boundary line of the target gamut; and
a color space conversion block to convert the second color signal into a color space of the initial color signal.

20. The apparatus of claim 19, wherein the gamut mapping block comprises:
a hue shift unit to perform a shift of the target gamut prior to the gamut mapping when the source gamut and the target gamut are highly different with respect to each other;
a calibration part to calibrate a cusp of the source gamut to be disposed at an extended line having the same slope as a cusp of the target gamut adjacent to the cusp of the source gamut and to calibrate the target gamut when the source gamut calibrated is highly different from the target gamut in comparison with the original source gamut;
a vector stretching unit to perform the gamut mapping by stretching a source point to the target point as much as a vector difference between a point at which the extended line of the vector meets with the boundary line of the source gamut and a point at which the extended line of the vector meets with the boundary line of the target gamut.

21. The apparatus of claim 20, wherein the gamut mapping block further comprises:
a chroma stretching unit to employ a chroma stretching for regions of the target gamut that are not subject to the vector stretching.

22. The apparatus of claim 19, further comprising:
a first color space conversion block to convert the initial color signal into the first color signal of the LCH color space.

23. The apparatus of claim 20, wherein the calibration part calibrates the cusp of the source gamut by downsizing a region of the source gamut disposed outside the target gamut and enlarging a region of the source gamut disposed inside the target gamut, and calibrates the target gamut when there is a high discrepancy in chroma and lightness between a cusp of a predetermined boundary line of the source gamut calibrated and a cusp of a predetermined boundary line of the target gamut.
